(19) United States
(12) Patent Application Publication
(10) Pub. No.: US 2006/0272800 A1
(43) Pub. Date: Dec. 7, 2006

(54) Radiator fan shroud with flow directing ports

(75) Inventors: Alec C. Wong, Bellevue, WA (US); Dan Farmer, Coupeville, WA (US); Brian G. Campbell, Seattle, WA (US); Adam J. Hailey, Deer Park, WA (US); Kevin Chou, Redmond, WA (US); Tim L. Schick, Duvall, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR Inc, Bellevue, WA (US)

(21) Appl. No.: 11/144,387

(22) Filed: Jun. 2, 2005

(51) Int. Cl. B29C 47/88

(52) U.S. Cl. 165/120

(57) ABSTRACT

A radiator fan shroud (100) is disclosed that is adapted to be attached to a vehicle radiator (96)—for example, the radiator of a Class 8 truck. The fan shroud includes a peripheral cover portion (112) and a ring assembly (102) that encloses the blades of the engine-driven radiator fan (88). The ring assembly may be formed integrally with the peripheral cover portion or may include a separable ring extension (120). The ring assembly includes a plurality of ports (104) defined by vanes (106) at the rearward portion of the ring assembly. The ports are selectively positioned to manage the airflow in the engine compartment, directing the airflow towards selected locations. The vanes may be fluted. The fan shroud may be formed from two or more pieces that cooperatively form the fan shroud, to facilitate installation and maintenance of the fan shroud.

### FIELD OF THE INVENTION

The present invention relates generally to engine cooling systems for vehicles such as trucks and, more particularly, to components for managing airflow through the radiator and into the engine compartment.

### BACKGROUND OF THE INVENTION

In typical automotive engine cooling systems, a coolant (primarily water) is circulated through the engine to transport heat away from the engine. Relatively cool water is transported through channels in the engine and transports away excess heat from the engine. The heated water then exits the engine and the relatively hot water circulates through a series of tubes in an external radiator located at the front of the vehicle. The series of tubes is generally provided with fins to improve the heat transfer performance. Airflow through the radiator convectively transports heat away, thereby cooling the circulating coolant. Relatively low temperature coolant then exits the radiator and is returned to the engine. An engine-driven fan is typically provided on the rear side (engine side) of the radiator to enhance the airflow through the radiator, significantly increasing the heat transfer from the circulating coolant. The fan is particularly important for maintaining airflow through the radiator when the vehicle is not moving. The fan is oriented to draw air rearwardly through the radiator and past the fan into the engine compartment. A radiator fan shroud is often provided, the fan shroud attaching to the rear side of the radiator and including a circular ring portion that surrounds the fan blades.

The coolant acts as a heat sink for the engine, removing waste heat and controlling the engine temperature. The more controlled the temperature of the coolant, the better the performance of the engine. Generally, increased airflow through the radiator will increase the convective heat transfer away from the coolant and improve the effectiveness of the radiator. For example, it is known that performance of the fan is better if the clearance between the fan blade tips and the fan shroud ring is minimized. Therefore, the shroud ring is typically relatively rigid and dimensioned to closely accommodate the fan blades.

In prior art vehicles, little consideration is given to the airflow after it has passed through the radiator and past the fan. The air typically encounters the engine block just downstream of the fan and is thereby turned outwardly within the engine compartment, creating a relatively high pressure region directly behind the fan.

Of course, during operation the engine compartment is a relatively warm environment and certain components within the engine compartment get particularly warm, either by receiving heat from other components or from internally generated heat (for example, the alternator, oil cooler, and the like). Also, there are many components in the engine compartment that may benefit if the mean and/or peak temperature that such components are exposed to were decreased (for example, hoses, belts, cables, seals, and the like). In addition, it will be appreciated that lower mean and/or peak temperature conditions in the engine compartment or in particular regions in the engine compartment would allow the designer a wider range of material choices for auxiliary components, thereby leading to potential savings in weight, production costs, and/or reliability.

There is a need, therefore, for systems and methods for improving the effectiveness of the radiator cooling—for example, by increasing the airflow through the radiator—and for systems and methods for decreasing the temperature within the engine compartment—and especially for providing directed cooling airflow to specific components or in certain directions in the engine compartment.

### SUMMARY OF THE INVENTION

A cooling system for a motor vehicle is disclosed. The system is suitable for use in a variety of different vehicle types and the currently preferred embodiment disclosed herein is particularly suitable for large commercial trucks. The vehicle cooling system includes a conventional radiator for removing waste heat from the engine coolant. A radiator fan, generally engine-driven, is disposed rearward of the radiator and is adapted to pull air through the radiator. A fan shroud attaches to the rear face of the radiator and includes a ring portion that houses the fan blades, such that the airflow drawn by the fan is substantially limited to air pulled through the radiator. The rearward end of the ring portion of the fan shroud includes a plurality of spaced-apart, rearward projections or vanes that cooperatively define a plurality of ports. The ports are preferably strategically positioned to direct the airflow rearward of the fan blades in desired directions—for example, to provide supplemental cooling to particular components in the engine compartment. The ports also provide additional outflow area rearward of the fan blades (as compared to a solid ring portion having the same length), thereby lowering the pressure between the fan blades and the engine and improving the fan efficiency.

In an embodiment of the invention, the ports are positioned to direct airflow toward or away from an alternator, starter motor, oil cooler, electronic control device, pollution control device, and/or fluid reservoir.

In an embodiment of the invention, the vanes on the ring portion of the fan shroud are not all the same length and are fluted.

In an embodiment of the invention, the ring portion of the fan shroud is formed integrally with the peripheral portion of the fan shroud.

In another embodiment of the invention, the ring portion includes a separable ring extension.

In an embodiment of the invention, the fan shroud is formed of an upper portion that is separable from the lower portion.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of an engine compartment of a prior art truck showing the radiator, fan shroud, fan, and engine block;

FIG. 2 is a schematic diagram of an engine compartment, showing a radiator fan shroud in accordance with the teachings of the present invention;

FIG. 3 is an exploded perspective view showing the radiator fan shroud of FIG. 2 in isolation;

FIG. 4 is a cross-sectional view of the ring extension for the fan shroud shown in FIG. 2; and

FIG. 5 is a perspective view of a second embodiment of a fan shroud, made in accordance with the present invention.

### DETAILED DESCRIPTION OF THE PREFERRED EMBODIMENT

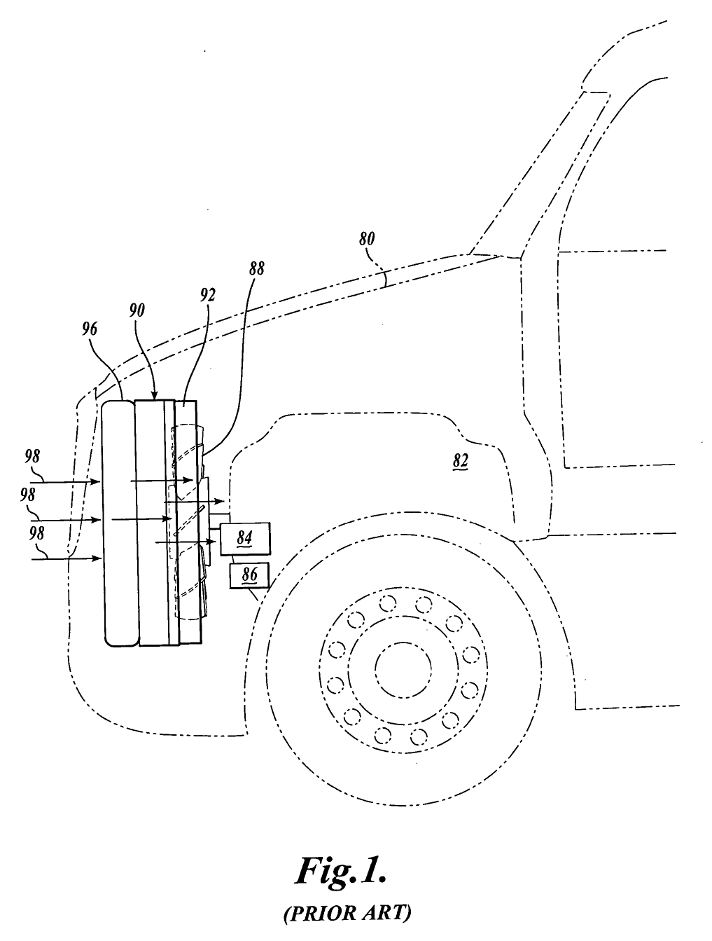

A currently preferred embodiment of the present invention will now be described with reference to the figures, wherein like numbers indicate like parts. Referring first to FIG. 1, a schematic sketch of the engine compartment of a truck 80 is shown, a partial outline of the truck 80 contour being shown in phantom. Although the present invention may be applied to other vehicles, such as passenger cars, vans, sports utility vehicles, and the like, the preferred embodiment will be described with reference to a truck—for example, a Class 8 commercial truck. A conventional engine 82 (also shown in phantom) is mounted inside the engine compartment of the truck 80. In addition to the engine 82, a number of auxiliary components are typically disposed in the engine compartment, denoted generically in FIG. 1 as 84 and 86, such as an alternator, starter motor, oil cooler, electronic control devices, pollution control devices, fluid reservoirs, and the like, and may include elements such as hoses, belts, cables, seals. A radiator 96 is disposed near the front of the truck 80, the radiator 96 receiving fluid coolant from the engine 82, cooling the fluid via convection of air through the radiator 96, and returning the coolant to the engine 82.

A radiator fan shroud 90 is attached to overlie a portion of the rear face of the radiator 96. An engine-driven fan 88 is disposed rearwardly of the radiator 96 and includes a plurality of blades that are substantially enclosed about their radial periphery by a rearwardly-extending ring portion 92 of the radiator fan shroud. The fan 88 is oriented such that during operation, the fan 88 draws air rearwardly, through the radiator 96, which airflow may be further enhanced by the forward motion of the truck 80 (if any), as indicated by the arrows 98. After passing through the radiator 96 and past the fan 88, the airflow encounters the engine 82, creating a local region of relatively high pressure as the airflow must turn to get around the engine 82. It will be appreciated by a person of skill in the art that this high-pressure region behind the fan 88 hinders the flow of air, thereby decreasing the airflow that the fan 88 can produce through the radiator 96. Moreover, in prior art systems the fan-induced airflow rearwardly of the fan 88 is generally ignored, with no means provided to productively manage the airflow.

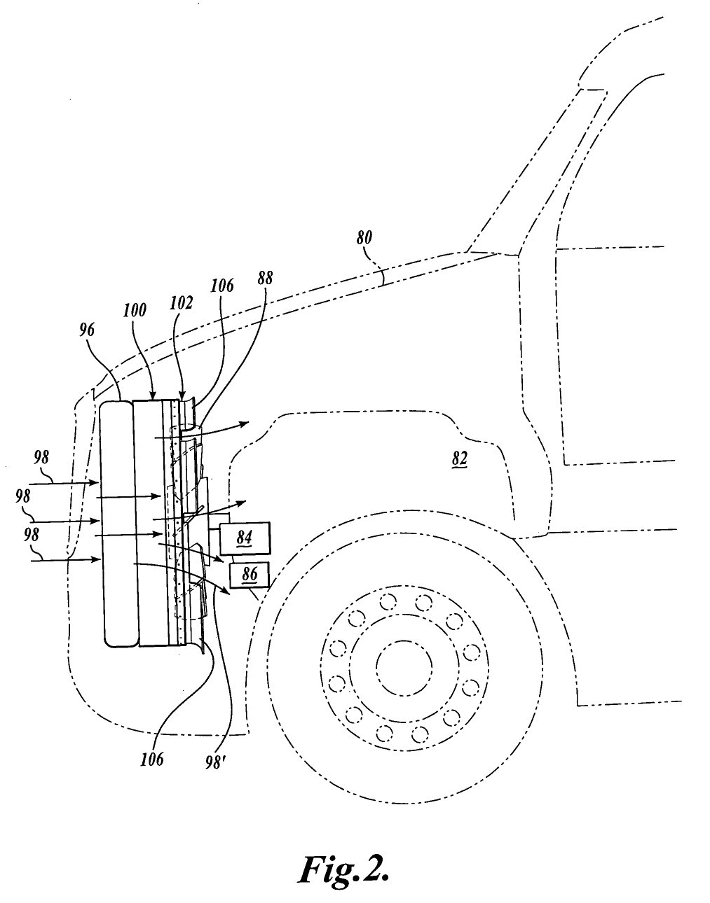

Refer now to FIG. 2, which shows the same truck 80 having the same engine 82 and auxiliary components 84, 86. The fan 88 and radiator 96 may also be the same as the corresponding components identified in the prior art system shown in FIG. 1. The radiator fan shroud 100, however, is significantly different from the fan shroud 90 of the above-described prior art system. In particular, the fan shroud 100 has a ring assembly 102 that includes a plurality of openings or ports disposed between and defined by a plurality of vanes 106. The plurality of ports are selectively located to produce a number of airflow streams that may be directed, for example, toward or away from particular auxiliary components 84, 86—for example, components 84, 86 that would benefit from additional air convention, as indicated diagramatically with arrows 98′.

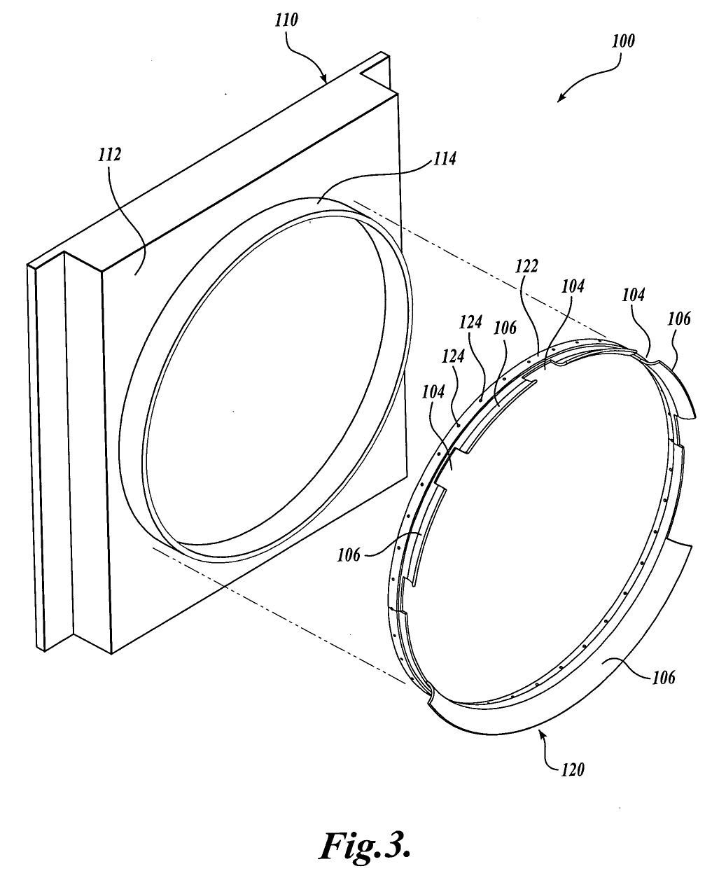

FIG. 3 is an exploded view of the fan shroud 100, which in this embodiment comprises two members, a main shroud portion 110 having a peripheral cover portion 112 and a main ring portion 114, and a ring extension 120 that engages the main ring portion 114. The ring assembly 102 (see FIG. 2), therefore, includes the main ring portion 114 and the ring extension 120. Although the cover portion 112 is shown as a substantially rectilinear member, it is contemplated that the cover portion 112 may be contoured to improve airflow through the radiator and/or alternatively shaped, for example, to provide clearance for other components in the engine compartment. The main shroud portion 110 may be, for example, a conventional fan shroud modified to shorten the main ring portion 114. An example of a prior art fan shroud suitable for use as the main shroud portion 110 is shown in U.S. Design Pat. No. D440,929, which is hereby incorporated by reference. It is also contemplated that the main shroud portion 110 may be formed of two or more pieces that are joined together—for example, with connecting hardware—in order to facilitate installation and maintenance of the fan shroud 100.

As seen most clearly in FIG. 3, the fluted vanes 106 of the ring extension 120 define a plurality of ports 104 that are disposed just downstream of the blades of the fan 88. The ports 104 are located in the region of relatively high pressure between the fan 88 and the engine 82 and, therefore, the ports 104 provide a relatively low pressure outlet for the air. By judicious placement of the ports 104, the airflow may be directed in a desired direction to optimize the airflow in the engine compartment. In addition, the ports 104 provide a larger area for the airflow behind the fan 88 (as compared with a conventional ring of the same length) and therefore will relieve some of the pressure between the fan 88 and the engine 82, increasing the efficiency of the fan and allowing a greater airflow through the radiator 96.

In this embodiment, the ring extension 120 includes a circular flange 122 that may provide a friction fit with the main ring portion 114 for slidably attaching the ring extension 120 to the main shroud portion 110. The ring extension 120 may include one or more apertures 124 to accommodate attachment hardware (not shown) for locking the ring extension 120 to the main ring portion 114.

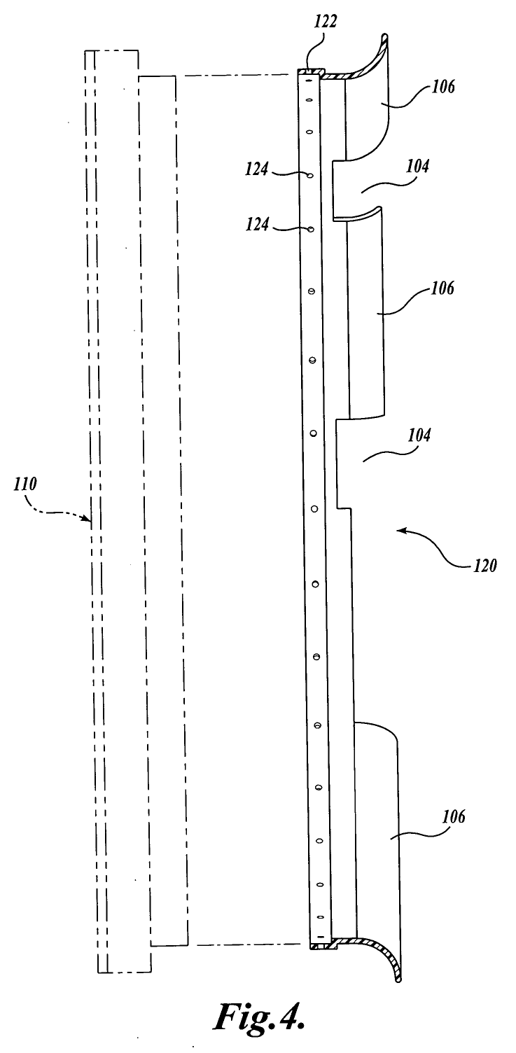

FIG. 4 shows a cross-sectional side view of the ring extension 120 with the main shroud portion 110 shown in phantom. As seen most clearly in this view, the vanes 106 of the ring extension 120 may optionally be fluted or curve outwardly to further manage the airflow rearward of the blades of the fan 88. Also, it is contemplated that the vanes 106 may extend varying distances rearwardly to optimize the airflow for a particular vehicle.

It will be appreciated that the use of the ring extension 120 allows a designer to optimize the flow in a particular vehicle configuration by changing a single, relatively inexpensive part, rather than having to redesign an entire fan shroud.

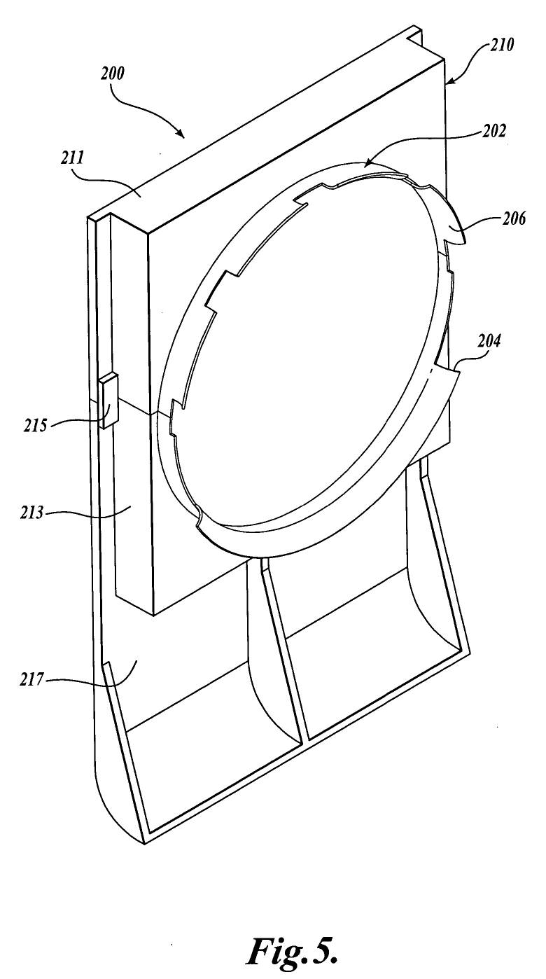

Another embodiment of a radiator fan shroud 200, according to the present invention, is shown in FIG. 5. It will be readily apparent to the artisan that this fan shroud 200 shares many of the aspects of the fan shroud 100 discussed above and, for clarity, the common aspects will not be reiterated here. In the fan shroud 200 the ring assembly 202 is formed integrally with the main shroud portion 210. It will be appreciated that the integral construction has obvious advantages in manufacturing costs and reliability. The ring assembly 202 includes a plurality of ports 204 and vanes 206 to allow the designer to better manage the airflow in the engine compartment, providing improved airflow through the radiator 96 and directing airflow to specific areas.

The main shroud portion 210 may be formed with an upper portion 211 and a separable lower portion 213. The upper shroud portion 211 is provided with a flange 215 that overlaps the lower portion 213 to facilitate alignment and attachment of the upper and lower portions 211, 213. It will be appreciated that the mechanical connection between the upper and lower portions 211, 213 may be accomplished by any convenient mechanism, including friction fitting or various attachment hardware, as are well known in the art. It will also be appreciated that providing the fan shroud 200 in two (or more) portions will facilitate installation and/or removal of the fan shroud 200, particularly in the common situation wherein clearance is limited.

The lower portion 213 of the fan shroud 200 shown in FIG. 5 includes an optional lower deflector portion 217 that extends below the fan 88 and generally deflects airflow rearwardly. It is known that in certain circumstances, generally when the vehicle is stationary, a portion of the airflow from the fan 88 (see, FIG. 2) that is deflected downwardly by the engine 82 can travel under the front of the vehicle and be recirculated by the fan 88 through the radiator 96. This air is, of course, warmer than the ambient air and it is therefore desirable to prevent recirculation through the radiator 96. The lower deflector portion 217 provides a barrier that tends to urge the air rearwardly to prevent or reduce such warm air circulation.

The fan shroud of the present invention may be made from any suitable materials as are well known in the art for fan shroud, including, for example, certain polymeric materials, composite materials (including fiberglass), or formable metals. The fan shroud must be rugged enough to endure for long durations the relatively hot and mechanically agitated environment in the engine compartment while having sufficient rigidity and dimensional stability to retain a relatively close tolerance with the fan. It is also desirable that the fan shroud be as lightweight as possible.

While the preferred embodiment of the invention has been illustrated and described, it will be appreciated that various changes can be made therein without departing from the spirit and scope of the invention.

1. A cooling system for a vehicle comprising:
a radiator having a front side and a rear side;
a fan having a plurality of blades, the plurality of blades disposed near the rear side of the radiator, the fan being operable to draw air in a direction from the front side of the radiator towards the rear side of the radiator; and
a fan shroud having a peripheral portion that attaches to the radiator, a circular ring portion that extends from the peripheral portion and around the fan blades;
wherein the ring portion includes a plurality of vanes defining a plurality of ports that direct airflow laterally.

2. The cooling system of claim 1, wherein at least one of the plurality of ports is positioned to direct an airflow towards an auxiliary component in an engine compartment of the vehicle.

3. The cooling system of claim 1, wherein at least one of the plurality of ports is positioned to direct an airflow away from an auxiliary component in an engine compartment of the vehicle.

4. The cooling system of claim 1, wherein the auxiliary component is selected from the following—an alternator, a starter motor, an oil cooler, an electronic control, a pollution control, and a fluid reservoir.

5. The cooling system of claim 1, wherein the vanes have varying lengths.

6. The cooling system of claim 1, wherein the fan shroud peripheral portion and the fan shroud circular ring portion are formed integrally.

7. The cooling system of claim 1, wherein the fan shroud ring portion comprises a main ring portion and a ring extension that is attached to the main ring portion.

8. The cooling system of claim 1, wherein the fan shroud comprises an upper shroud portion and a lower shroud portion that attaches to the upper shroud portion.

9. The cooling system of claim 1, wherein the fan shroud further comprises a downwardly extending airflow deflector.

10. The cooling system of claim 1, wherein at least some of the plurality of vanes are fluted.

11. A radiator fan shroud comprising:
a peripheral portion adapted to attach to a radiator, and
a tubular ring portion that extends from the peripheral portion, wherein the tubular ring portion includes a plurality of vanes defining a plurality of ports that direct airflow laterally.

12. The radiator fan shroud of claim 10, wherein at least one of the plurality of ports is positioned to direct an airflow toward an auxiliary component in an engine compartment of a vehicle.

13. The radiator fan shroud of claim 10, wherein at least one of the plurality of ports is positioned to direct an airflow away from an auxiliary component in an engine compartment of a vehicle.

14. The radiator fan shroud of claim 10, wherein the plurality of vanes have varying lengths.

15. The radiator fan shroud of claim 10, wherein the fan shroud peripheral portion and the fan shroud tubular ring portion are formed integrally.

16. The radiator fan shroud of claim 10, wherein the fan shroud ring portion comprises a main ring portion and a ring extension that is attached to the main ring portion.

17. The radiator fan shroud of claim 10, wherein the fan shroud comprises an upper shroud portion and a lower shroud portion that attaches to the upper shroud portion.

18. The radiator fan shroud of claim 10, wherein the fan shroud further comprises a downwardly extending airflow deflector.

19. The radiator fan shroud of claim 10, wherein at least some of the plurality of vanes are fluted.
